(19) United States
(12) Patent Application Publication
(10) Pub. No.: US 2016/0184635 A1
(43) Pub. Date: Jun. 30, 2016

(54) Method and apparatus for transmitting and receiving data using bluetooth

(71) Applicant: LG Electronics Inc., Seoul (KR)

(72) Inventor: Younghwan KWON, Seoul (KR)

(73) Assignee: LG Electronics Inc., Seoul (KR)

(21) Appl. No.: 14/757,562

(22) Filed: Dec. 24, 2015

Related U.S. Application Data
(60) Provisional application No. 62/096,544, filed on Dec. 24, 2014.
(60) Provisional application No. 62/217,824, filed on Sep. 12, 2015.

(51) Int. Cl. A63B 24/00; H04W 76/02; H04W 4/20; H04W 4/00

(52) U.S. Cl. CPC A63B 24/0062; H04W 4/008; H04W 76/02; H04W 4/20; A63B 24/0087

(57) ABSTRACT

A method for transmitting and receiving data by a client device with a fitness device using Bluetooth, includes receiving an advertising message including at least one of type information of the fitness device or service information indicating whether a fitness service is provided, from the fitness device, performing a connection procedure with the fitness device, transmitting a request message requesting feature information that may be provided by the fitness device from the fitness device, receiving a response message including the feature information from the fitness device, transmitting a first write request message including first control information for controlling the fitness device on the basis of the feature information, and receiving a first write response message with respect to the first write request message, wherein the feature information is information related to the fitness service.

### CROSS-REFERENCE TO RELATED APPLICATIONS

This application claims the benefit under 35 U.S.C. §119(e) to U.S. Provisional Application No. 62/096,544 filed on 24 Dec., 2014 and No. 62/217,824 filed on 12 Sep., 2015, the entire contents of which is hereby incorporated by reference in its entirety.

### BACKGROUND OF THE INVENTION

1. Field of the Invention

The present invention relates to a method and apparatus for transmitting and receiving data between devices using Bluetooth, a near-field communication (NFC) technology, in a wireless communication system, and more particularly, to a method and apparatus for transmitting and receiving data between devices using a Bluetooth basic rate/enhanced data rate (BR/EDR) or Bluetooth low energy (BLE) technology.

2. Description of the Related Art

Bluetooth is an NFC technology standard allowing various devices to be wirelessly connected in a near field to exchange data. In a case in which two devices intend to perform wireless communication using Bluetooth communication, a user may perform a procedure for discovering a Bluetooth device with which he or she wants to communicate and requesting a connection. In the present disclosure, a device may refer to an apparatus or an appliance.

Here, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since a transmission distance thereof is 100 m at the maximum, and thus, Bluetooth is appropriately used within a limited space.

### SUMMARY

An aspect of the present invention provides a method for controlling a connection between a first device and a second device using a Bluetooth technology.

According to an aspect of the present invention, there is provided a method for transmitting and receiving data by a client device with a fitness device using Bluetooth, including: receiving an advertising message including at least one of type information of the fitness device or service information indicating whether a fitness service is provided, from the fitness device; performing a connection procedure with the fitness device; transmitting a request message requesting feature information of the fitness device from the fitness device; receiving a response message including the feature information from the fitness device; transmitting a first write request message including first control information for controlling the fitness device based on the feature information; and receiving a first write response message in response to the first write request message, wherein the feature information is information related to the fitness service.

The feature information may include at least one of device information indicating information of the fitness device or exercise information indicating an exercising motion of a user.

The method may further include: transmitting a second write request message requesting write of user data to the fitness device; and receiving a second write response message in response to the second write request message.

The method may further include: when the user data is updated by the fitness device, receiving the updated user data from the fitness device.

The method may further include: transmitting a scan request message for requesting additional information to the fitness device; and receiving a scan response message including the additional information in response to the scan request message.

The method may further include: when a specific value of the updated user data exceeds a predetermined threshold value, receiving a notification message including alarm information indicating that the updated the specific value exceeds the predetermined threshold value.

The method may further include: transmitting a third write request message including operation type information indicating an operation method of the fitness device; and receiving a third write response message in response to the third write request message.

The operation method may be one of automatic control, manual control, and interactive control.

The method may further include: when the operation method indicates automatic control, transmitting scheduling information for setting the operation method to the fitness device. The scheduling information is comprised of one or more objects.

The scheduling information may include at least one of time information indicating an operation time, operation information indicating a scheduling operation, and a set value of an operation.

The method may further include: when the operation method indicates manual control, receiving a second control information for controlling a specific operation of the fitness device from a user or other device; transmitting a second write request message including the second control information to the fitness device; and receiving a second write response message in response to the second write request message.

The method may further include: when the operation method indicates interactive control, transmitting a second write request message including the second control information to the fitness device according to a set scheduling information; and receiving a second write response message in response to the second write request message.

According to another aspect of the present invention, there is provided a device including: a communication unit configured to communicate with the fitness device wirelessly or in a wired manner; and a processor functionally connected to the communication unit, wherein the processor is configured to perform control to receive an advertising message including at least one of type information of the fitness device and service information indicating whether a fitness service is provided, from the fitness device, perform a connection procedure with the fitness device, transmit a request message requesting feature information that can be provided by the fitness device to the fitness device, receive a response message including the feature information from the fitness device, transmit a write request message including control information for controlling the fitness device on the basis of the feature information, and receive a write response message in response to the write request message, wherein the feature information indicates information related to the fitness service.

According to the method for transmitting and receiving data using the Bluetooth BR/EDR and LE technology according to an embodiment of the present invention, data may be transmitted and received between devices.

Also, according to an embodiment of the present invention, data may be transmitted and received by controlling a device using the Bluetooth BR/EDR and LE technology.

Also, according to an embodiment of the present invention, an operation method of a device may be set by using the Bluetooth BR/EDR and LE technology.

Also, according to an embodiment of the present invention, data of a device may be updated and the updated data may be transmitted and received by using the Bluetooth BR/EDR and LE technology.

Advantages and effects of the present invention are not limited to the foregoing contents and any other technical effects not mentioned herein may be easily understood by a person skilled in the art from the present disclosure and accompanying drawings.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating an example of a wireless communication system using a Bluetooth low energy technology to which the present invention is applicable.

FIG. 2 is an internal block diagram of an example of devices to which the present invention is applicable.

FIG. 3 is a view illustrating an example of a Bluetooth low energy topology.

FIG. 4 is a view illustrating an example of a Bluetooth communication architecture to which the present invention is applicable.

FIG. 5 is a view illustrating an example of a structure of a generic attribute profile (GATT) of Bluetooth low energy.

FIG. 6 is a flow chart illustrating a method of establishing a connection using Bluetooth low energy (LE) between devices.

FIGS. 7 through 10 are views illustrating a method for transmitting and receiving data using Bluetooth LE and examples of a data format to which the present invention is applicable.

FIGS. 11 and 12 are views illustrating examples of a data type to which the present invention is applicable.

FIGS. 13 through 17 are views illustrating examples of characteristics to which the present invention is applicable.

FIG. 18 is a view illustrating another example of a method for transmitting and receiving data using Bluetooth LE to which the present invention is applicable.

FIG. 19 is a view illustrating another example of a method for transmitting and receiving data using Bluetooth LE to which the present invention is applicable.

FIG. 20 is a view illustrating another example of a method for transmitting and receiving data using Bluetooth LE to which the present invention is applicable.

FIGS. 21 through 24 are views illustrating an example of a method for setting an operation method of a device and a data format to which the present invention is applicable.

FIGS. 25 through 27 are views illustrating examples of a method for transmitting and receiving data using Bluetooth BR/EDR and a data format to which the present invention is applicable.

### DETAILED DESCRIPTION

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

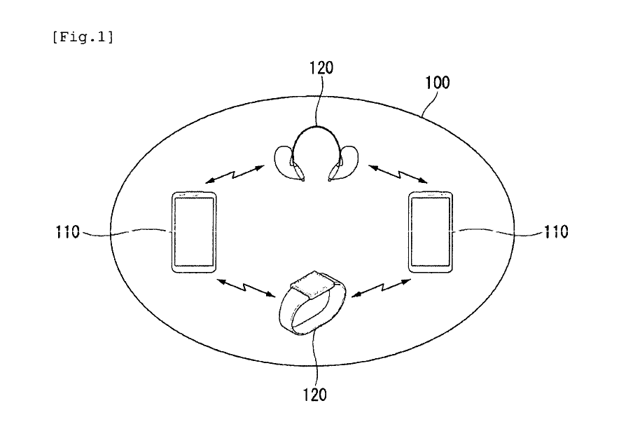

FIG. 1 is a schematic view illustrating an example of a wireless communication system using a Bluetooth low energy technology to which the present invention is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be called as data service device, slave device, slave, server, conductor, host device, gateway, sensing device, monitoring device, first device, or the like, and the client device 110 may also be called as master device, master, client, member, sensor device, sink device, collector, second device, third device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

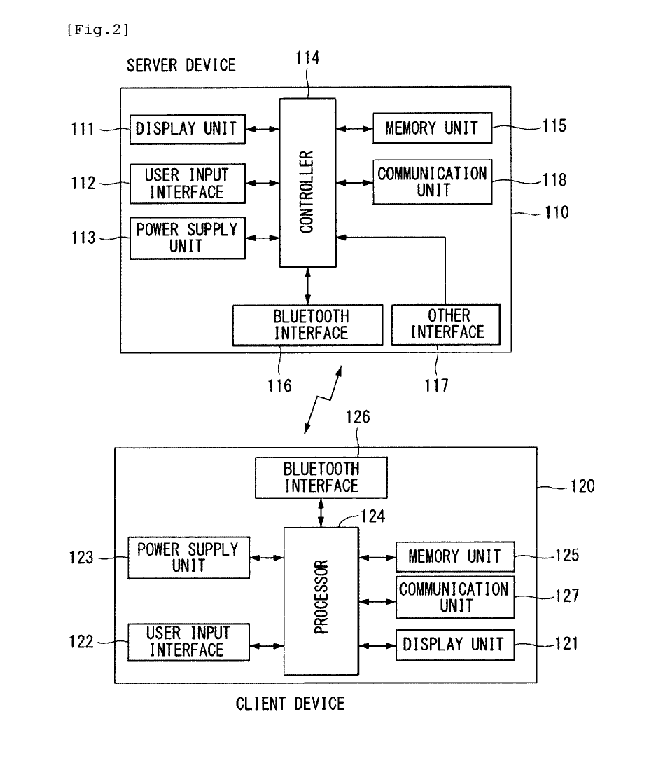

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

Also, a plurality of devices measuring exercising activities of human beings through a fitness equipment using a specific device have been presented, but a device transmitting measured exercising data through Bluetooth to show specific numerical values to users has not been introduced yet.

Thus, the present invention proposes a method for measuring human beings' exercising activities through the fitness equipment and transmitting and processing measured data through Bluetooth LE to provide the processed data to users.

FIG. 2 is an internal block diagram of an example of devices to which the present invention is applicable.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117, and the communication unit 118 are functionally connected to each other to perform a method proposed in this disclosure.

Also, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127, and the communication unit 128 are functionally connected to each other to perform a method proposed in this disclosure.

The Bluetooth interfaces 116 and 126 refer to units (or modules) able to transmit data such as a request/a response, a command, a notification, an indication/confirmation message between devices.

The memory units 115 and 126 are units implemented in various types of devices, in which various types of data are stored.

The processors 114 and 124 refer to modules controlling a general operation of the server device or the client device, which control requesting transmission of a message through the Bluetooth interface and other interface and processing a received message therethrough.

The processors 114 and 124 may also be termed a controller, a control unit, and the like.

The processors 114 and 124 may include an application-specific integrated circuit (ASIC), other chip set, a logic circuit and/or data processing unit.

The processors 114 and 124 control the communication units to receive an advertising message from the server device, control the communication unit to transmit a scan request message to the server device and receive a scan response message as a response to the scan request from the server device, and control the communication unit to transmit a connection request message to the server device in order to establish a Bluetooth connection with the server device.

Also, after the Bluetooth LE connection is established through the connection procedure, the processors 114 and 124 control the communication units to read or write data by using an attribute protocol from the server device

The memory units 115 and 125 may include a read-only memory (ROM), a random access memory (RAM), a flash memory, a memory card, a storage medium and/or other storage device.

The communication units 118 and 127 may include a baseband circuit for processing a wireless signal. When an embodiment is implemented by software, the aforementioned technique may be implemented as a module (process, function, etc.) performing the aforementioned function. The module may be stored in a memory unit and may be executed by a processor.

The memory units 115 may be present within or outside of the processors 114 and 124, and may be connected to the processors 114 and 124 through various well-known units.

The display units 111 and 121 refer to modules providing status information of the devices, message exchange information, and the like, to the user through a screen.

The power supply units 113 and 123 refer to modules receiving external power or internal power and supplying power required for operations of the respective components under the control of the controllers 114 and 124.

As discussed above, in the BLE technology, a duty cycle is small and power consumption may be significantly reduced through a low data rate.

The user input interfaces 112 and 122 refer to modules providing a user input such as a screen button to the controllers to enable the user to control an operation of the devices.

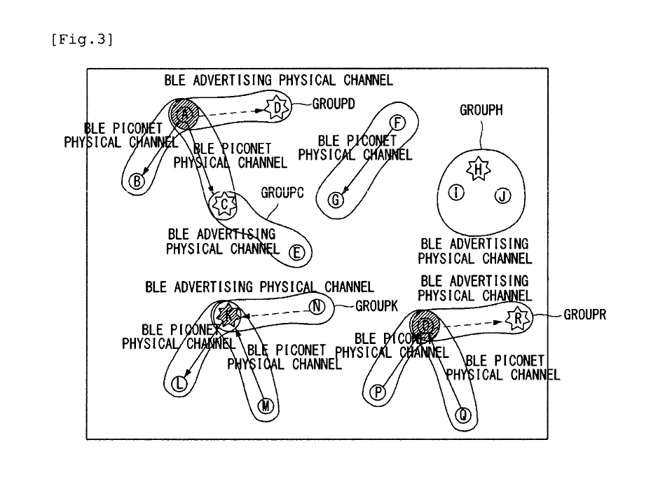

FIG. 3 is a view illustrating an example of a Bluetooth low energy topology.

Referring to FIG. 3, a device A corresponds to a master in a piconet (piconet A, the shaded portion) having a device B and a device C as slaves.

Here, the piconet refers to an aggregation of devices in which any one of them is a mater and the other devices occupy a shared physical channel connected to the master device.

The BLE slaves do not share a common physical channel with the master. Each of the slaves communicates with the master trough a separate physical channel. There is another piconet (piconet F) having a master device F and a slave device G.

A device K is present in a scatternet K. Here, the scatternet refers to a group of piconets connected to other piconets.

The device K is a master of a device L and a slave of a device M.

A device O is also in the scatter net O. The device O is a slave of a device P and a slave of a device Q.

As illustrated in FIG. 2, five different device groups are present.
1. Device D is an advertiser and device A is an initiator (group D).
2. Device E is a scanner and Device C is an advertiser (group C).
3. Device H is an advertiser, and devices I and J are scanners (group H).
4. Device K is also an advertiser, and device N is an initiator (group K).
5. Device R is an advertiser, and device O is an initiator (group R).

The devices A and B use a single BLE piconet physical channel.

The devices A and C use another BLE piconet physical channel.

In group D, the device D advertises using an advertisement event connectable in an advertisement physical channel, and the device A is an initiator. The device A may establish a connection with the device D and add a device to the piconet A.

In group C, the device C advertises on an advertisement physical channel by using a certain type of an advertisement event captured by the scanner device E.

The group D and the group C may use different advertisement physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertisement physical channel. The device H is an advertiser, and the devices I and J are scanners.

In the scatternet K, the devices K and L use a single BLE piconet physical channel. The devices K and M use another BLE piconet physical channel.

In group K, the device K advertises by using an advertisement event connectable on an advertisement physical channel, and the device N is an initiator. The device N may establish a connection with the device K. Here, the device K may be a slave of two devices and a master of one device at the same time.

In the scatternet O, the devices O and P use a single BLE piconet physical channel. The devices O and Q use another BLE piconet physical channel.

In group R, the device R advertises by using an advertisement event connectable on an advertisement physical channel, and the device O is an initiator. The device O may establish a connection with the device R. Here, the device O may be a slave of two devices and a master of one device at the same time.

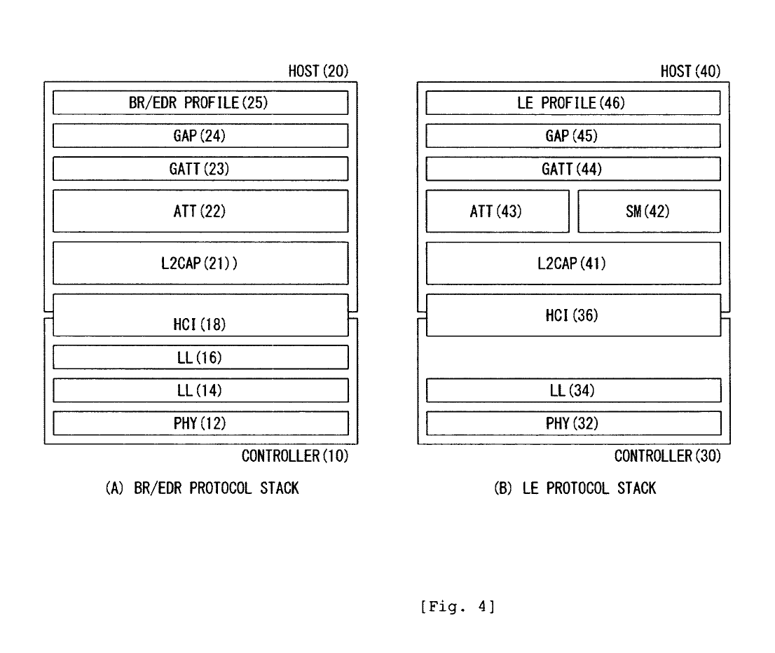

FIG. 4 is a view illustrating an example of a Bluetooth communication architecture to which the present invention is applicable.

Referring to FIG. 4, (a) of FIG. 4 illustrates an example of a protocol stack of a Bluetooth basic rate (BR/enhanced data rate (EDR) that supports GATT (Generic Attribute Profile), and (b) of FIG. 4 illustrates an example of a protocol stack of Bluetooth low energy (LE).

In detail, as illustrated in (a) of FIG. 4, the Bluetooth BR/EDR protocol stack may include an upper controller stack 10 and a lower host stack 20 with respect to a host controller interface (HCI) 18.

The host stack (or host module) 20 refers to hardware for transmitting or receiving a Bluetooth packet to and from a wireless transceiver module receiving a Bluetooth signal of 2.4 GHz, and is connected to a Bluetooth module, the controller stack 10, to control the Bluetooth module and performs an operation.

The host stack 20 may include a BR/EDR PHY layer 12, a BR/EDR baseband layer 14, and a link manager 16.

The BR/EDR PHY layer 12 is a layer transmitting and receiving a 2.4 GHz wireless signal, and in case of using Gaussian frequency shift keying (GFSK) modulation, the BR/EDR PHY layer 12 may transmit data by hopping 79 RF channels.

The BR/EDR baseband layer 14 serves to transmit a digital signal, selects a channel sequence hopping 1400 times per second, and transmits a time slot having a length of 625 us for each channel.

The link manager layer 16 controls a general operation (link setup, control, security) of a Bluetooth connection by utilizing a link manager protocol (LMP).

The link manager layer 16 may perform the following functions.
The link manager layer 16 may perform ACL/SCO logical transport, logical link setup, and control
Detach: The link manager layer 16 stops connection and informs a counterpart device about the reason for stopping connection.
The link manager layer 16 performs power control and role switch.
The link manager layer 16 performs security (authentication, pairing, encryption) function.

The host controller interface layer 18 provides an interface between the host module and the controller module to allow the host to provide a command and data to the controller and allow the controller to provide an event and data to the host.

The host stack (or host module) 20 includes a logical link control and adaptive protocol (L2CAP) 21, an attribute protocol (ATT) 22, a generic attribute profile (GATT) 23, a generic access profile (GAP) 24, and a BR/EDR profile 25.

The logical link control and adaptive protocol (L2CAP) 21 may provide a two-way channels for transmitting data to a specific protocol or a profile.

The L2CAP 21 may multiplex various protocols and profiles provided from a Bluetooth higher position.

The L2CAP of the Bluetooth BR/EDR uses a dynamic channel, supports a protocol service multiplexer, retransmission, and a streaming mode, and provides segmentation and reassembly, per-channel flow control, and error control.

The generic attribute profile (GATT) 23 may operate as a protocol how the attribute protocol 22 is used in configuring services. For example, the generic attribute profile 23 may operate how ATT attributes are grouped together with services, and operate to describe features associated with services.

Thus, the GATT 23 and the ATT 22 may use features in order to describe status and services of a device and describe how the features are related and used.

The attribute protocol 22 and the BR/EDR profile 25 define a service (profile) using the Bluetooth BR/EDR and define an application protocol for exchanging data, and the generic access profile (GAP) 24 defines device discovering, connecting a device and security level.

As illustrated in (b) of FIG. 4, the Bluetooth LE protocol stack includes a controller stack 30 operable to process a wireless device interface for which timing is important, and a host stack 40 operable to process high level data.

First, the controller stack 30 may be implemented by using a communication module that may include a Bluetooth wireless device, for example, a processor module that may include a processing device such as a microprocessor.

The host stack may be implemented as part of an OS operated on a processor module or may be implemented as instantiation of a package on the OS.

In some examples, the controller stack and the host stack may be operated or executed on the same processing device within a processor module.

The controller stack 30 includes a physical layer (PHY) 32, a link layer (LL) 34, and a host controller interface (HCI) 36.

The physical layer (PHY) (wireless transceiver module 32), a layer for transmitting and receiving a 2.4 GHz wireless signal, uses a Gaussian frequency shift keying (GFSK) modulation and a frequency hopping technique including forty RF channels.

The link layer (LL) 34 serving to transmit or receive a Bluetooth packet provides a function of generating a connection between devices after performing an advertising and scanning function using three advertising channels, and exchanging data packets of a maximum of 257 bytes through thirty-seven data channels.

The host stack may include a generic access profile (GAP) 40, a logical link control and adaptation protocol (L2CAP) 41, a security manager (SM) 42, an attribute protocol (ATT) 43), a generic attribute profile (GATT) 44, a generic attribute profile (GAP) 45, and an LE profile 46. However, the host stack 40 is not limited thereto and may include various protocols and profiles.

The host stack multiplexes various protocols and profiles provided from a Bluetooth higher position by using the L2CAP.

First, the L2CAP 41 may provide a single two-way channel for transmitting data to a specific protocol or profile.

The L2CAP 41 may operate to multiplex data between higher layer protocols, segment and reassemble packages, and manage a multicast data transmission.

In the Bluetooth LE, three fixed channels (one for a signaling channel, one for a security manager, and one for an attribute protocol) are basically used, and dynamic channel may be used as necessary.

In contrast, in the BR/EDR, a dynamic channel is basically used, and a protocol service multiplexer, retransmission, streaming mode, and the like, are supported.

The SM 42 is a protocol for certifying a device and providing a key distribution.

The ATT 43 defines a rule for accessing data of a counterpart device by a server-client structure. The ATT 43 includes six types of messages (request, response, command, notification, indication, and confirmation) as follows.

\textcircled{1} Request and Response message: A request message is a message for a client device to request specific information from a server device, and the response message, as a response message with respect to the request message, refers to a message transmitted from the server device to the client device.

\textcircled{2} Command message: It is a message transmitted from the client device to the server device in order to indicate a command of a specific operation. The server device does not transmit a response with respect to the command message to the client device.

\textcircled{3} Notification message: It is a message transmitted from the server device to the client device in order to notify an event, or the like. The client device does not transmit a confirmation message with respect to the notification message to the server device.

\textcircled{4} Indication and confirmation message: It is a message transmitted from the server device to the client device in order to notify an event, or the like. Unlike the notification message, the client device transmits a confirmation message regarding the indication message to the server device.

In the present invention, when the GATT profile using the attribute protocol (ATT) 43 requests long data, a value regarding a data length is transmitted to allow a client to clearly know the data length, and a characteristic value may be received from a server by using a universal unique identifier (UUID).

The generic access profile (GAP) 45, a layer newly implemented for the Bluetooth LE technology, is used to select a role for communication between Bluetooth LED devices and to control how a multi-profile operation takes place.

Also, the generic access profile (GAP) 45 is mainly used for device discovery, connection generation, and security procedure part, defines a scheme for providing information to a user, and defines types of attributes as follows.

\textcircled{1} Service: It defines a basic operation of a device by a combination of behaviors related to data

\textcircled{2} Include: It defines a relationship between services

\textcircled{3} Characteristics: It is a data value used in a server

\textcircled{4} Behavior: It is a format that may be read by a computer defined by a UUID (value type).

The LE profile 46, including profiles dependent upon the GATT, is mainly applied to a Bluetooth LE device. The LE profile 46 may include, for example, Battery, Time, FindMe, Proximity, Time, Object Delivery Service, and the like, and details of the GATT-based profiles are as follows.

Battery: Battery information exchanging method

Time: Time information exchanging method

FindMe: Provision of alarm service according to distance

Proximity: Battery information exchanging method

Time: Time information exchanging method

The generic attribute profile (GATT) 44 may operate as a protocol describing how the attribute protocol (ATT) 43 is used when services are configured. For example, the GATT 44 may operate to define how ATT attributes are grouped together with services and operate to describe features associated with services.

Thus, the GATT 44 and the ATT 43 may use features in order to describe status and services of a device and describe how the features are related and used.

Hereinafter, procedures of the Bluetooth low energy (BLE) technology will be briefly described.

The BLE procedure may be classified as a device filtering procedure, an advertising procedure, a scanning procedure, a discovering procedure, and a connecting procedure.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

Here, the advertising device refers to a device transmitting an advertisement event, that is, a device performing an advertisement and is also termed an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request.

Advertising Procedure

The advertising device performs an advertizing procedure to perform undirected broadcast to devices within a region.

Here, the undirected broadcast is advertizing toward all the devices, rather than broadcast toward a specific device, and all the devices may scan advertising to make an additional information request or a connection request.

In contrast, directed advertising may make an additional information request or a connection request by scanning advertising for only a device designated as a reception device.

The advertising procedure is used to establish a Bluetooth connection with an initiating device nearby.

Or, the advertising procedure may be used to provide periodical broadcast of user data to scanning devices performing listening in an advertising channel.

In the advertising procedure, all the advertisements (or advertisement events) are broadcast through an advertisement physical channel.

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertisement device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of user data from advertising devices using an advertising physical channel.

The scanning device transmits a scan request to an advertising device through an advertising physical channel in order to request additional data from the advertising device. The advertising device transmits a scan response as a response with respect to the scan request, by including additional user data which has requested by the scanning device through an advertising physical channel.

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode.

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel.

Both the discovering device and the discoverable device may have already been connected with other Bluetooth devices in a piconet.

Connecting Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier.

Scanning State

The LL enters the scanning state according to an instruction from the host (stack). In the scanning state, the LL listens to advertising channel indices.

The scanning state includes two types: passive scanning and active scanning. Each of the scanning types is determined by the host.

Time for performing scanning or an advertising channel index are not defined.

During the scanning state, the LL listens to an advertising channel index in a scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device.

Initiating State

The LL enters the initiating state according to an instruction from the host (stack).

When the LL is in the initiating state, the LL performs listening on advertising channel indices.

During the initiating state, the LL listens to an advertising channel index during the scan window interval.

Connection State

When the device performing a connection state, that is, when the initiating device transmits a CONNECT_REQ PDU to the advertising device or when the advertising device receives a CONNECT_REQ PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in an Bluetooth interface will be briefly described. BLE devices use packets defined as follows.

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.

ADV_IND: Connectable undirected advertising event

ADV_DIRECT_IND: Connectable directed advertising event

ADV_NONCONN_IND: Unconnectable undirected advertising event

ADV_SCAN_IND: Scannable undirected advertising event

The PDUs are transmitted from the LL in an advertising state, and received by the LL in a scanning state or in an initiating state.

Scanning PDU

The following advertising channel DPU types are termed scanning PDUs and are used in a state described hereinafter.

SCAN_REQ: Transmitted by the LL in a scanning state and received by the LL in an advertising state.

SCAN_RSP: Transmitted by the LL in the advertising state and received by the LL in the scanning state.

Initiating PDU

The following advertising channel PDU type is termed an initiating PDU.

CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure.

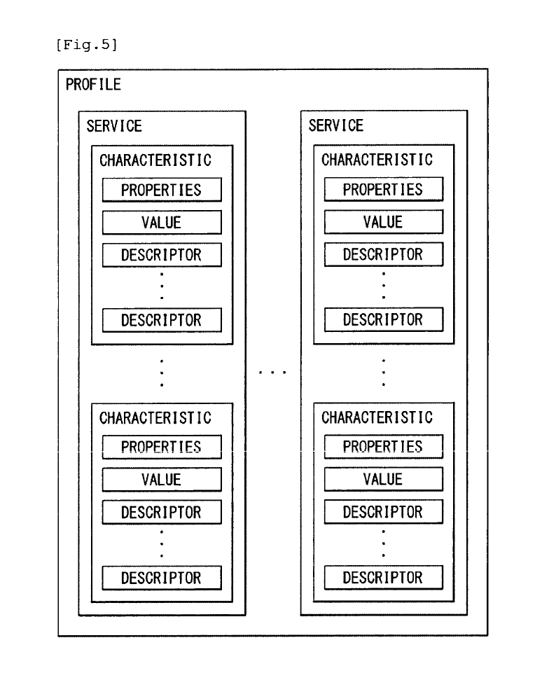

FIG. 5 is a view illustrating an example of a structure of a generic attribute profile (GATT) of Bluetooth low energy.

Referring to FIG. 5, a structure for exchanging profile data of Bluetooth low energy may be looked through.

In detail, the GATT defines a method for exchanging data using a service between Bluetooth LE devices and a characteristic.

In general, a peripheral device (for example, a sensor device) serves as a GATT server, and has definition regarding a service and a characteristic.

In order to read or write data, a GATT client sends a data request to the GATT server, and every operation (transaction) is started by the GATT client and a response is received from the GATT server.

A GATT-based operational structure used in the Bluetooth LE may be a vertical structure as illustrated in FIG. 5 on the basis of a profile, a service, and a characteristic.

The profile includes one or more services, and the services may include one or more characteristics or other services.

The service serves to divide data into logical units and may include one or more characteristics or other services, each of the services has a 16-bit or 128-bit identifier called a universal unique identifier (UUID)).

The characteristic is the lowermost unit in the GATT-based operational structure. The characteristic includes only one data, and has a 16-bit or 128-bit UUID, similar to the service.

The characteristic is defined by values of various types of information, and in order to hold each information, an attribute may be required for each information. The characteristic may use several continuous attributes.

The attribute has four components and has meanings as follows.
handle: Address of attribute
Type: Type of attribute
Value: Value of attribute
Permission: Right to access attribute

The present invention proposes a method in which a sensor measures and stores human activities by using a GATT-based operational structure of the Bluetooth LE, and a client retrieves the stored information from the sensor.

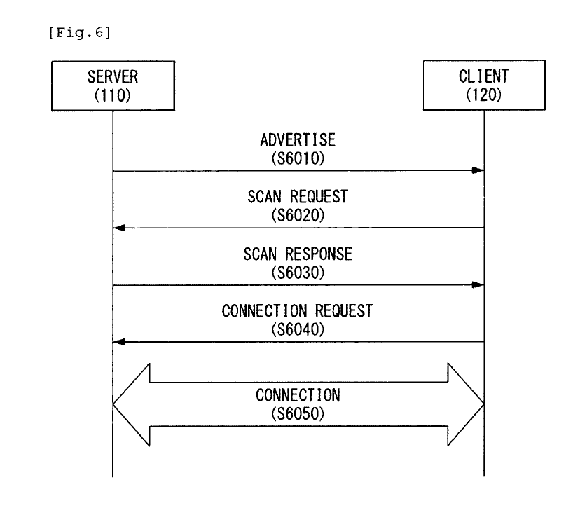

FIG. 6 is a flow chart illustrating a method of establishing a connection using Bluetooth low energy (LE) between devices.

As illustrated in FIG. 6, for a Bluetooth LE connection between a server device 110 and a client device 120, the server device 110 transmits an advertising message to the client device 120 (S6010).

The advertising message is used for a device to provide information thereof to other device by utilizing the Bluetooth LE, and may include various types of information such as service information, user data, and the like, provided by the device.

The client device 120 checks information included in the advertising message transmitted from the server device 110, and when additional information regarding the server device 110 is required, the client device 120 may transmit a scan request message to the server device 110 (S6020).

When a scan request message is received from the client device 120, the server device 110 includes the requested additional information in a scan response message and transmits the same to the client device 120 (S6030).

The step S6020 and the step S6030 are selective and not essential.

When the server device 110 is a device intended to be connected on the basis of an advertising message and/or the information included in the scan response message, the client device 120 transmits a connection request messages for a connection to the server device 110 (S6040).

Thereafter, the server device 110 and the client device 120 establishes a Bluetooth LE connection (S6050).

However, a protocol for controlling a fitness device (gym equipment) or exchanging information of the fitness device using the Bluetooth LE technology has not been defined. In particular, incase of information regarding a fitness device, since different data is measured according to different types of fitness devices, there is a difficulty in providing consistent information.

Thus, the present invention defines a service (hereinafter, a fitness device service) of Bluetooth capable of effectively transmitting and receiving information of a fitness device by controlling an operation of the fitness device and data that can be provided through the service and provides a method for transmitting and receiving data on the basis of the defined service and data.

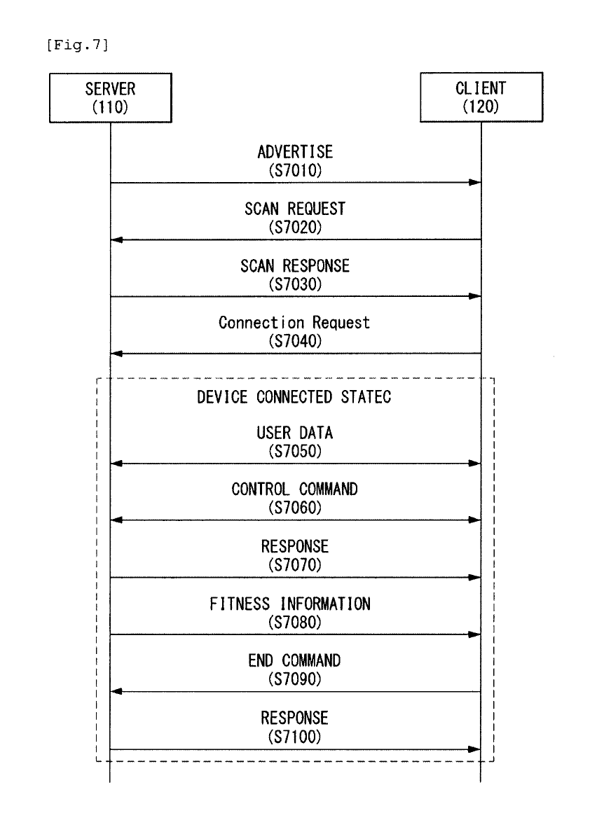

FIGS. 7 through 10 are views illustrating a method for transmitting and receiving data using Bluetooth LE and examples of a data format to which the present invention is applicable.

Referring to FIGS. 7 through 10, when a server device (hereinafter, referred to as a “fitness device”) and a client device are connected, information of the fitness device may be transmitted and received.

In detail, the fitness device 110 may transmit information of the fitness device 110 and service information indicating whether the fitness device 110 may be able to provide a fitness device service to a nearby device through an advertising message (S7010).

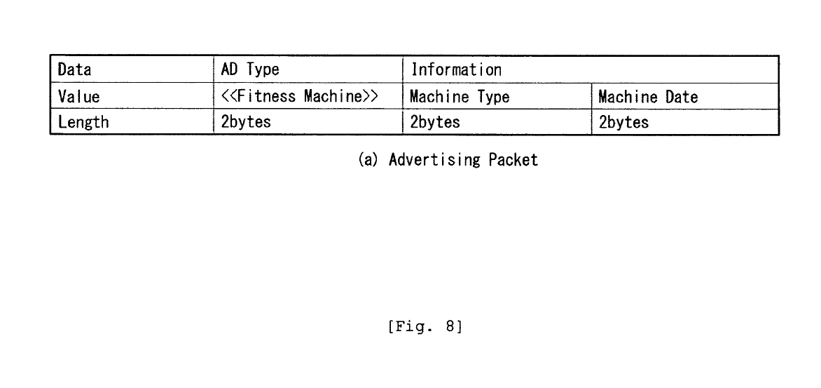

A packet format of the advertising message may include an AD Type and information as illustrated in FIG. 8.

The AD Type may indicate a type of the advertising message, and the information may include a Machine Type field including type information of the fitness device and a Machine data field including information related to the fitness device.

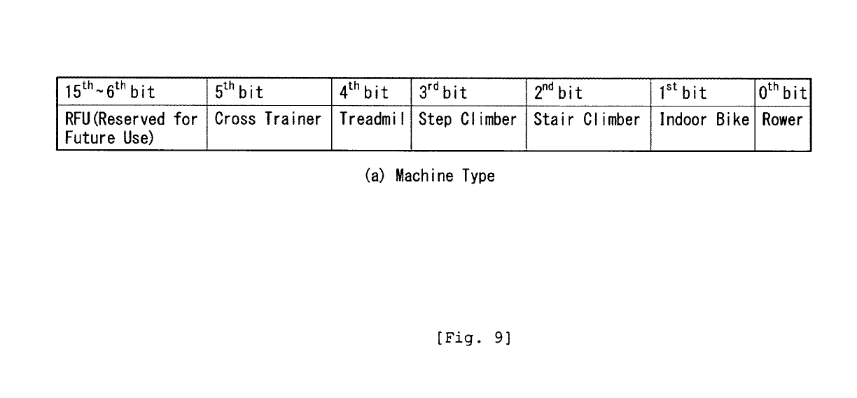

The Machine Type field may include bit information as illustrated in (a) of FIG. 9 or may be configured by an enumeration method as illustrated in (b) of FIG. 9. Here, when the Machine Type field includes the bit information, each bit indicates a type of a fitness device.

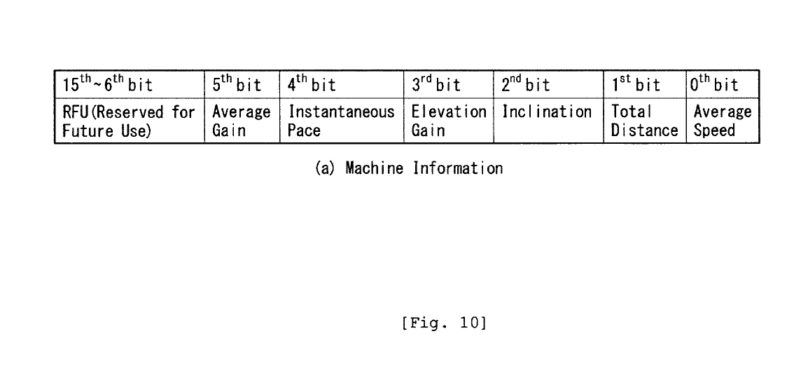

As illustrated in FIG. 10, in the Machine Data field, information that may be provided by the fitness device 110 includes bit information. Here, a bit of information that may be provided may be indicated by 1.

The information that may be provided may include device information as information of the fitness device 110 and exercise information related to an exercising motion of the user using the fitness equipment.

When additional information regarding the fitness device 110 is required, the client device 120 may transmit a scan request message to the fitness device 110 (S7020) and transmit a scan response message including the additional information to the client device 120 as a response (S7030).

When the fitness device 110 is a device intended to be connected, the client device 120 may transmit a connection request message to the fitness device 110 and perform a connection through Bluetooth LE with the fitness device 110 (S7040).

The client device 120 connected to the fitness device 110 through the Bluetooth LE may provide user data, for example, personal information and exercise information required for the fitness device 110 to measure exercise information of the user, to the fitness device 110 (S7050).

The user data is transmitted or received through user data service in Bluetooth.

The personal information may include body information of the user, for example, weight and height information, and the exercise information may include fitness time information and fitness strength information.

Thereafter, when a specific event occurs, the client device 120 may inform the fitness device 110 about the specific event, or may transmit a control command for controlling the fitness device to the fitness device 110 (S7060), and receive a response thereof from the fitness device 110 (S7070).

The fitness device 110 may measure exercise information of the user periodically a periodically, and may transmit the measured exercise information and user data updated on the basis of the measured exercise information to the client device (S7080).

Here, the exercise information and the updated user data may be different according to devices.

In a case in which the operation of the fitness device 110 is terminated, the client device 120 may transmit end command in order to inform the fitness device 110 of the termination of the fitness device service to the fitness device 110 (S7090), and may receive a response with respect thereto from the fitness device 110 (S7100).

Or, the fitness device 110 may transmit a termination command in order to inform the client device 120 of the termination of the operation to the client device 120, and may receive a response with respect thereto from the client device 120.

In another embodiment of the present invention, the client device 120 may read the exercise information and the updated user data from the fitness device 110.

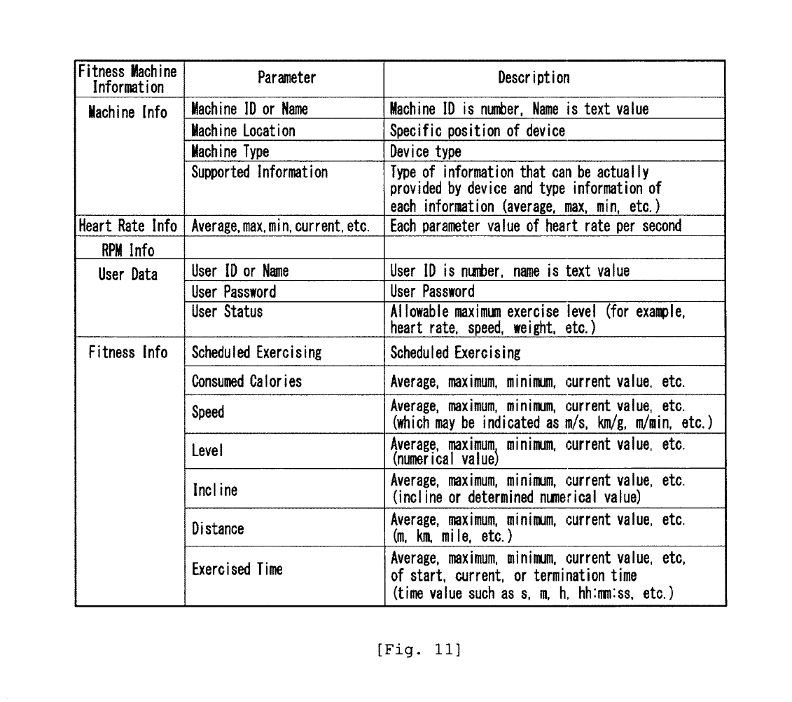

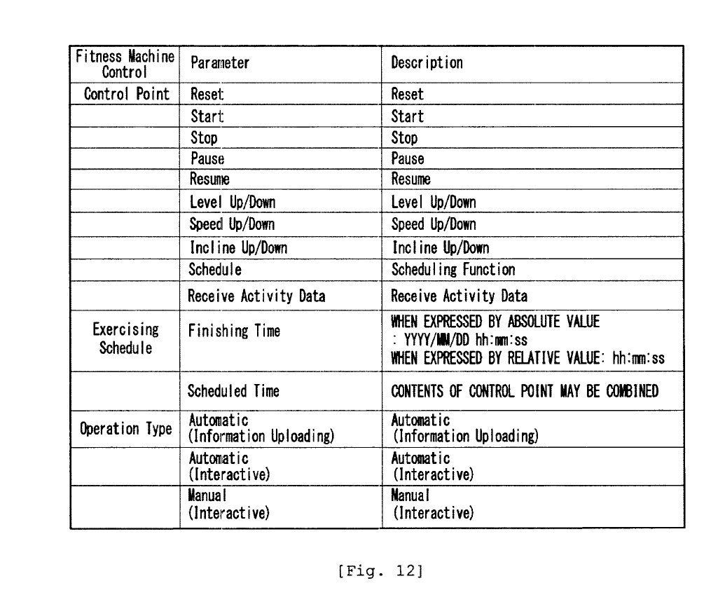

FIGS. 11 and 12 are views illustrating examples of a data type to which the present invention is applicable.

FIG. 11 illustrate an example of information that may be provided in the present invention, and FIG. 12 illustrates parameters for the client device 120 to control the server device 110.

The pieces of information illustrated in FIG. 11 may be transmitted through an advertising message or a scan response message, or may be stored in an object transfer service or a GATT database and provided after devices are connected.

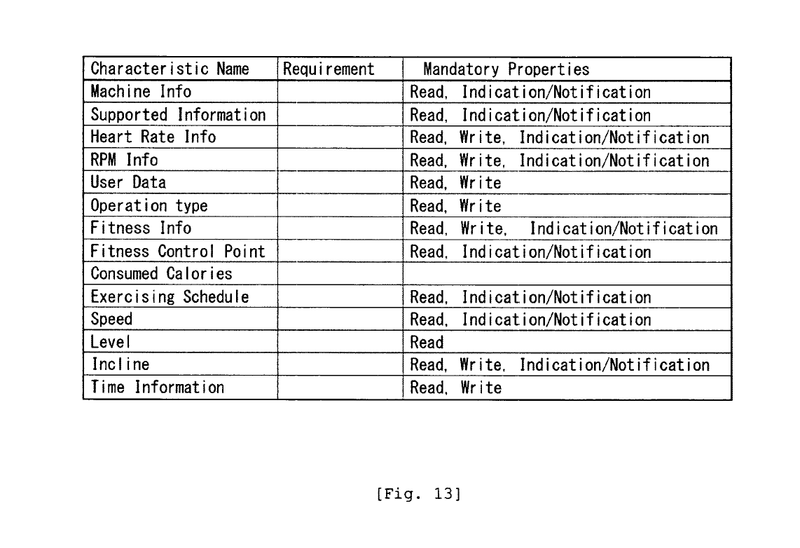

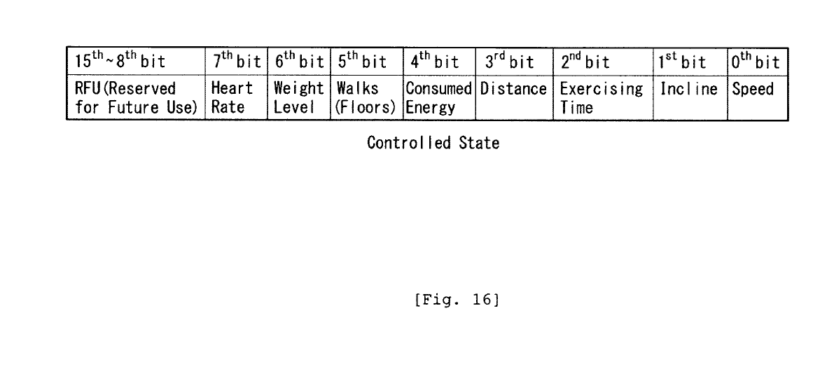

FIGS. 13 through 17 are views illustrating examples of characteristics to which the present invention is applicable.

FIG. 13 illustrates an example of a characteristic stored in the GATT database of the fitness device 110. The characteristic may include data for the client device 120 to set the fitness device and set a fitness, and exercise information performed by the fitness device 110 may be provided to the client device 120 according to a request from the client or directly.

Each of the characteristics will be described.
Machine Info: It provides information of a fitness device
Supported Information: Type of information that can be provided by the fitness device and type information of each information ((for example, average, maximum, minimum)
Heart Rate Info: Heart beat information of the user of the fitness device
RPM Info: Exercise information that may be provided to the same device such as a treadmill, and information provided from the client device is processed and output
User Info: User data of a fitness device service, based on which user's exercise information may be checked.
Operation type: An operation method between fitness device and client device.
   Automatic (Uploading Object): The client device is uploaded to the fitness device using information of a fitness schedule as an object, and the fitness device operates on the basis of the uploaded information
   Automatic (Interactive): Information of a fitness schedule is stored in the client device, and when an operation of the fitness device is intended to be controlled, a message is transmitted to the fitness device to control the operation of the fitness device
   Manual (Interactive): Fitness schedule information is received from the outside, and the received information is transmitted to the fitness device to control it.
Fitness Info: Present or past exercise information
   Related information is managed in the form of an object file
   Total of consumed calories
   Exercise information by date (fitness type, calorie, time, fitness strength, etc.)
Fitness Control Point: Function for controlling a value of current exercise information or an operation of the fitness device (for example, speed control and fitness start/end, etc.)
Consumed calories: Information of calories consumed during exercise (fitness) (it may be notified to the client device by time or at every predetermined numerical value)
Exercising Schedule: Reserved fitness time information for utilizing reserved exercise information is provided or a related function is provided
Speed: Function related to a speed required for fitness is provided (for example, highest, lowest, current speed information, etc.)
Level: Information of strength of fitness required for fitness is provided (for example, highest, lowest, and current strength information, etc.)
Incline: Tilt information of the fitness device required for fitness is provided (for example, highest, lowest, and current tilt information, etc.)
Time information: Time information is provided

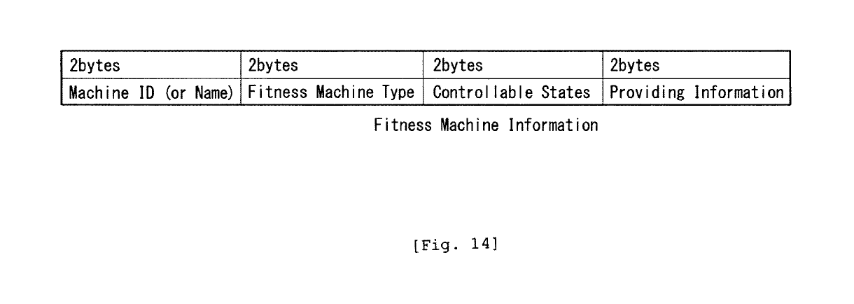

FIG. 14 illustrates an example of Machine Info among the characteristics illustrated in FIG. 13, in which the Machine Info may include Machine ID, Fitness Machine Type, Controllable State, and Providing Information.

The Machine ID, information for identifying a fitness machine, may include an ID or a name of a fitness machine and may be longer than 2 bytes.

The Fitness Machine Type indicates a type of a device, that is, which type of fitness the fitness device provides.

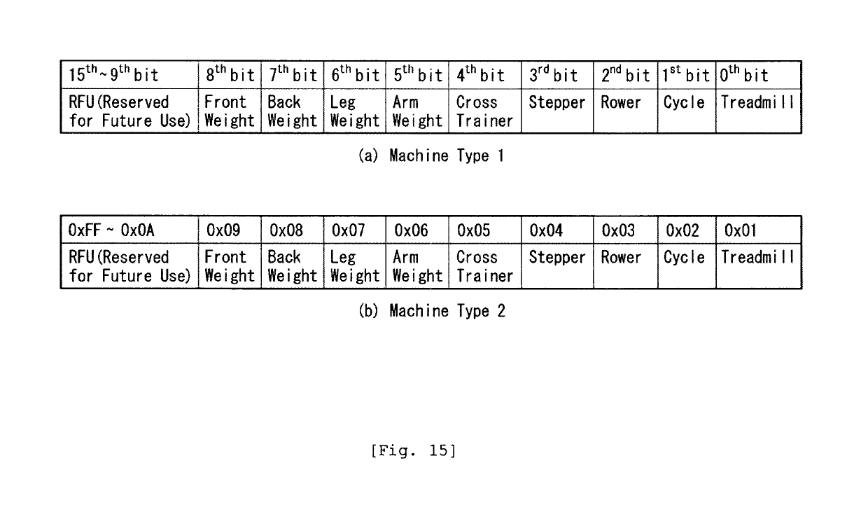

The Fitness Machine Type is configured in the form of bits as illustrated in (a) of FIG. 15 or as an enumeration type as illustrated in (b) of FIG. 15, or may have such a configuration as that of FIG. 9.

The Controlled State indicates a state that may be controlled by the fitness device and may be configured as illustrated in FIG. 15.

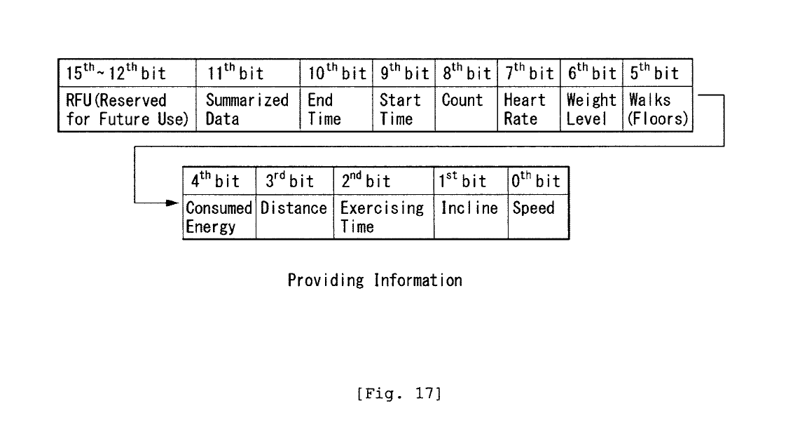

The Providing Information (or Feature Information) indicates information that may be provided by the fitness device and may be configured as illustrated in FIG. 17.

For example, the Providing Information may include device information related to the fitness device and exercise information related to an exercising activity using the fitness equipment of the user.

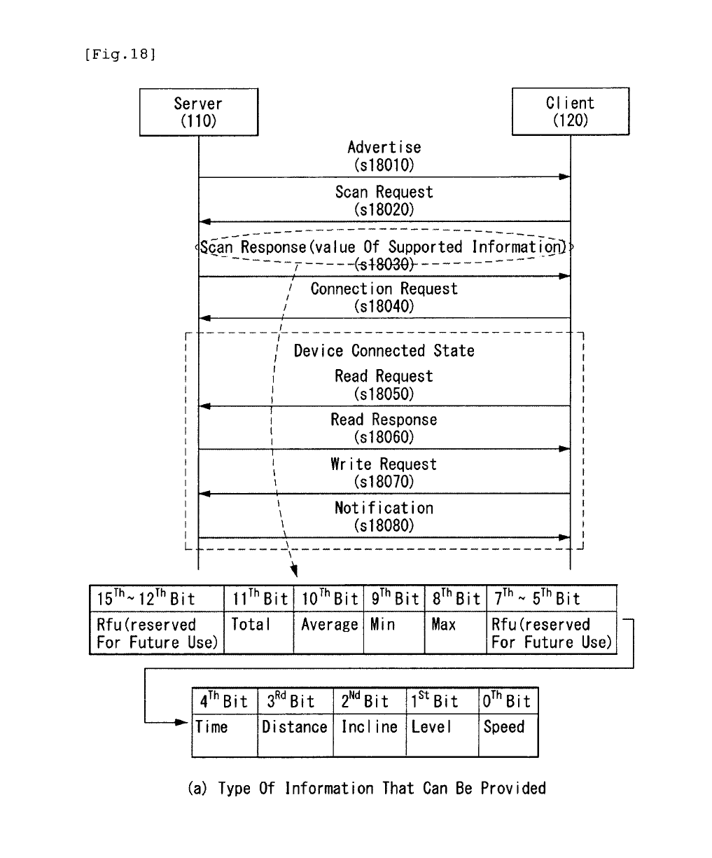

FIG. 18 is a view illustrating another example of a method for transmitting and receiving data using Bluetooth LE to which the present invention is applicable.

Referring to FIG. 18, the client device may obtain a service and information that may be provided by the fitness device through an advertising message or a scan response message from the fitness device.

First, step S18010 is the same as step S7010 of FIG. 7, so a description thereof will be omitted.

The client device 120 may know a type of the fitness device 110 and that the fitness device 110 provides a fitness device service through the advertising message transmitted from the fitness device 110.

Thereafter, in a case in which additional information of the fitness device 110 (for example, a type of information that may be provided) is required, the client device 120 may transmit a scan request message to the fitness device 110 (S18020).

Upon receiving the scan request message, the fitness device 110 may include the additional information (for example, a type of information that may be provided) requested by the client device in a scan response message, and transmit the scan response message to the client device 120 (S18030).

If the additional information is a type of information that may be provided in relation to the fitness device service by the fitness device 110, the additional information may be a configuration as illustrated in (a) of FIG. 18.

When the fitness device 110 has a device type desired to be connected and a type of information that may be provided, the client device 120 may transmit a connection request message to the fitness device 110 to perform a connection procedure with the fitness device 110 (S18040).

Thereafter, in a case in which types of the information that may be provided are not entirely received through the scan response message, the client device 120 may transmit a read request message to the fitness device 110 to request transmission of information included in the supported information of the GATT database discussed above with reference to FIG. 13 (S18050).

In response to the read request message, the fitness device 110 may include the information included in the supported information in a read response message, and transmit the read response message to the client device 120 (S18060).

In a case in which the fitness device 110 does not provide desired information, the client device 120 may transmit a write request message to the fitness device 110 to set the desired information in the supported information of the GATT characteristic of the fitness device 110 (S18070).

Thereafter, the fitness device 110 may transmit the information set by the client device 120 to the client device 120 through a notification message (S180800)

In another embodiment of the present invention, in a case in which the fitness device 110 does not transmit a notification message, the client device 120 may transmit a read request message to the fitness device 110 as in step S18050 and step S18060 to receive the set information.

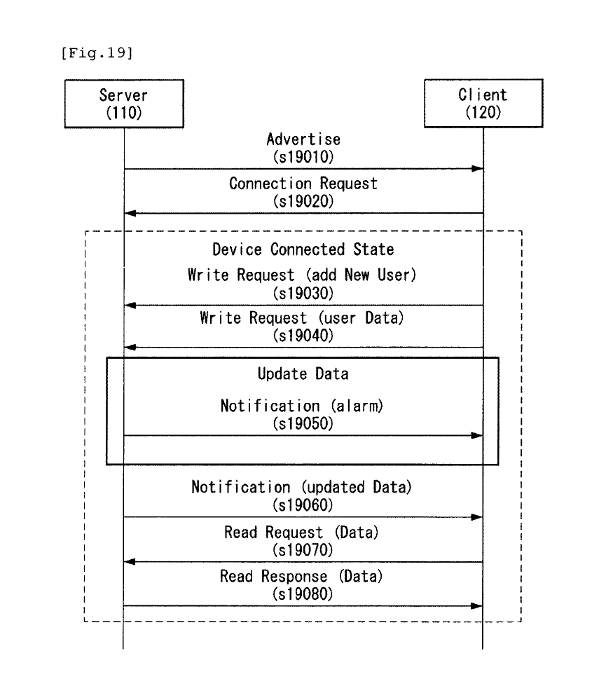

FIG. 19 is a view illustrating another example of a method for transmitting and receiving data using Bluetooth LE to which the present invention is applicable.

Referring to FIG. 19, the client device may input new user data to the fitness device, and may receive user's exercise information from the fitness device.

First, step S19010 and step S19020 are the same as step S7010 and step S7040 of FIG. 7, so a description thereof will be omitted.

When the client device 120 or the user of the client device first accesses the fitness device service, the client device 120 or the user of the client device transmits a write request message to the fitness device 120 in order to generate information of the client device 120 and/or information of the user (S19030).

In a case in which user data is generated through the write request message, since the user data is first generated, extra information has not been stored and the user may be confirmed through a separate identification code.

Thereafter, in order to set specific personal information of the client device and/or specific personal information of the user, the client device may write request message including the device information and/or personal information to the fitness device 110 (S19040).

Here, the personal information may include user's name, body information, exercise information (for example, a distance, a speed, a level, an incline, an exercise time, and a heart rate, etc) exercised in other device, and health information (for example, a critical heart rate, a critical blood-sugar level, etc.).

The information set in step S19040 may be corrected through a write request message afterwards.

When the user starts fitness though the fitness device 110, the fitness device 110 may measure an exercising motion of the user and update information (the exercise information and/or health information) related to the exercising motion.

For example, the fitness device 110 may update the consumed calories, the distance, the speed, the level, the incline, the exercise time, the heart rate, and the like.

When a value of information related to the exercising motion are updated, if a specific value of the updated value exceeds the health information (a predetermined threshold value), the fitness device 110 may transmit a notification message for warning or alarming to the client device 120 (S19050) and lower an exercise level.

For example, when the updated heart rate exceeds the critical heart rate (a predetermined threshold value), the fitness device 110 may transmit a warning message to the client device 120 and lower the exercise level.

The fitness device 110 may transmit the updated exercise information and health information to the client device 120 through a notification message (S19060).

When the exercising motion of the user is terminated, the client device 120 may transmit a read request message to the fitness device 110 in order to request changed or updated exercise information and/or health information after the termination of the fitness (S19070).

In response to the read request message, the fitness device 110 may transmit a read response message including the updated exercise information and/or health information to the client device 120 (S19080).

In another embodiment of the present invention, even though the notification message of step S19060 is not received, the client device 120 may transmit the read request message and receive a read response message with respect thereto to receive the changed or updated exercise information and/or health information.

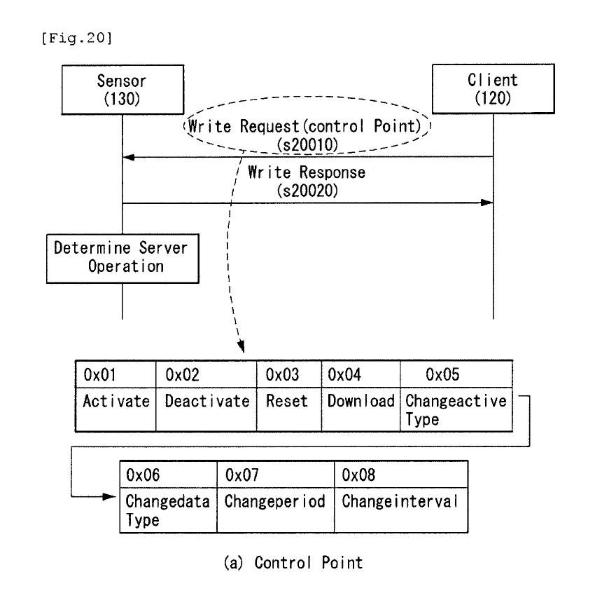

FIG. 20 is a view illustrating another example of a method for transmitting and receiving data using Bluetooth LE to which the present invention is applicable.

Referring to FIG. 20, the client device 120 may control a sensor for measuring the exercising motion of the user of the fitness device 110 to determine an operation of the sensor.

In the following descriptions, it is assumed that the client device 120 and the fitness device 110 are connected through Bluetooth LE.

In order to control an operation of the sensor for measuring the exercising motion of the user, the client device 120 may transmit a write request message including control information (or a control point) to the sensor 130 of the fitness device (S20010).

The control information may be configured as illustrated in (a) of FIG. 20, and may include a parameter for controlling the sensor 130 other than the parameters included in (a) of FIG. 20.

The parameters illustrated in (a) of FIG. 20 are as follows.
Activate: The sensor starts monitoring the exercising motion of the user. Sub-parameters include Monitoring Activity Type indicating an operation type desired to be monitored and Monitoring Data Type indicating a type of data desired to be monitored, and activities of the corresponding parameters are monitored.
Deactivate: The sensor terminates monitoring the exercising body motion of the user. Sub-parameters include Monitoring Activity Type indicating an operation type desired to be terminated from monitoring and Monitoring Data Type indicating a type of data desired to be terminated from monitoring, and activities of the corresponding parameters are monitored.
Reset: The sensor initializes data obtained by monitoring a specific exercising motion. Sub-parameters include Monitoring Activity Type indicating an operation type desired to be initialized and Monitoring Data Type indicating a type of data desired to be initialized, and monitoring data of activities of the corresponding parameters are initialized.
Download: Monitoring data regarding a specific exercising motion is requested from the sensor. Sub-parameters include Monitoring Activity Type indicating an operation type of data to be requested and Monitoring Data Type indicating a type of data desired to be requested, and values of monitoring data of activities of the corresponding parameters are requested (which can be downloaded in the form of a file and a data streaming through an L2CAP channel).
ChangeActiveType: The sensor device changes a type of a monitored exercising activity. A sub-parameter may include Monitoring Activity Type indicating a type of the exercising activity desired to be changed, and activities of the corresponding parameter are monitored.
ChangeDataType: The sensor changes a data type of monitored exercising activities. A sub-parameter may include Monitoring Activity Type indicating a type of data desired to be changed, and a data type of the corresponding parameter is changed.
ChangePeriod, ChangeInterval: The sensor changes a transmission period and measurement interval of a notification/indication message of a monitored value. Transmission period and measurement interval values of a notification/indication message are changed by this parameter, and an operation of the sensor according to the corresponding values is changed.

In response to the write request message, the sensor 130 may transmit a write response message to the client device 120, and change an operation on the basis of control information transmitted from the client device 120 (S20020).

In this manner, the client device 120 may control the parameters measured by the fitness device 110.

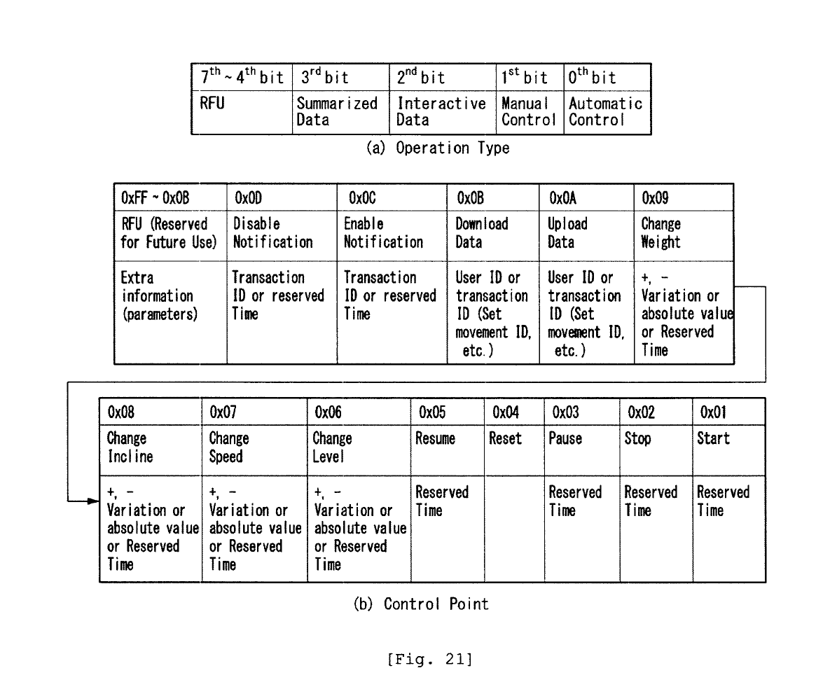

FIGS. 21 through 24 are views illustrating an example of a method for setting an operation method of a device and a data format to which the present invention is applicable.

Referring to FIGS. 21 through 24, the client device 120 may set an operation method of the fitness device 110 providing a fitness device service, and may measure an exercising motion of the user by controlling a specific operation according to the set operation method.

(a) of FIG. 21 illustrates an example of an operation type of GATT characteristic for setting an operation method of the fitness device described above with reference to FIG. 13.

The client device 120 may set an operation of the fitness device in an operation type of the GATT characteristic of the fitness device through a write request of a specific operation.

(b) of FIG. 21 illustrates an example of a control point of the GATT characteristic for controlling the fitness device described above with reference to FIG. 13.

The client device 120 may control the fitness device through a write request of a parameter desired to be controlled in a control point of the GATT characteristic of the fitness device.

Hereinafter, a method for setting and controlling an operation method of the fitness device according to the operation type and the control point will be described.

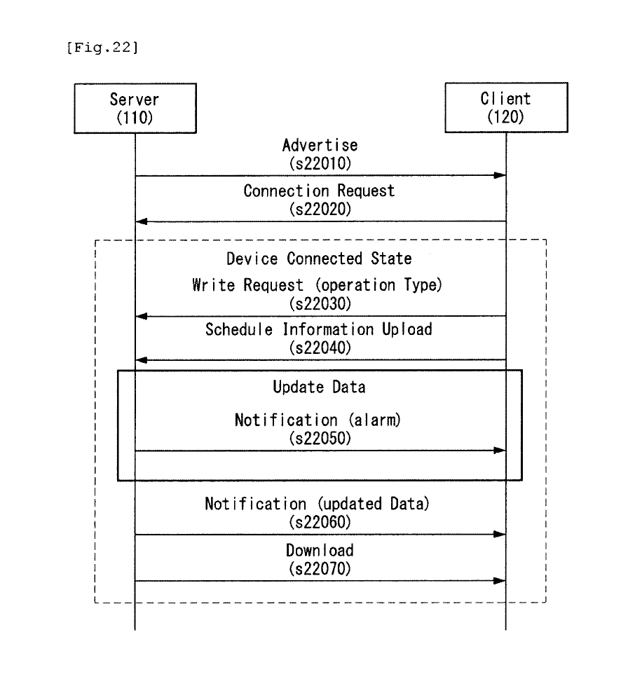

FIG. 22 is a view illustrating an example of a method for setting an operation type of the fitness device to Automatic Control of (a) of FIG. 21 and a corresponding operation of the fitness device.

First, step S22010 and step S22020 are the same as step S7010 and step S7040 of FIG. 7, so a description thereof will be omitted.

In order to set an operation type of the fitness device to Automatic Control, the client device 120 transmits a write request message to the fitness device (S22030).

Thereafter, the client device 120 uploads fitness schedule information of the user to the server device 110 (S22040). Here, the fitness schedule information may be uploaded through a method as follows.
When the fitness schedule information is an object type of information, the schedule information is uploaded using an object transfer service (OTS).
When the fitness schedule information is smaller than a maximum size of data of ATT, information is input to corresponding characteristic through a write long characteristic value function.

Here, the schedule information may include the exercise information and the health information described above with reference to FIG. 19, and the exercise information may have a format as illustrated in Table 2 below.

TABLE 2

| | | |
|---|---|---|
| Time information | Control item | Control value |

The control item indicates an operation to be controlled (for example, a speed, an incline, and the like).

The control value indicates a specific value or a changed value of the control item. As for the changed value, a value obtained by adding the changed value to a previous value is applied to the fitness device.

The time information indicates a time operated with the control item and the control value and may be expressed as the passage of time with respect to a start time of an exercising motion of the user and may be expressed as a difference from a previous value. For example, when the previous value is 00:05:00 and the value of the time information is 00:02:00, it may be 00:07:00 after two minutes.

In addition to the format of Table 2, the exercise information may be expressed in various forms, and when the exercise information is uploaded to the fitness device, the fitness device may be operated by itself according to the exercise information of the schedule information.

For example, when the exercise information is the same as illustrated in Table 3 below, the fitness device may start to operate at a speed of 5, adjust the incline to 5 in five minutes, changes the speed to 6 in 20 seconds to operate, and changes the speed to 8 in one minute and forty seconds to operate.

TABLE 3

| Time information | Control item | Control value |
|---|---|---|
| 00:00:00 | Speed | 5 |
| 00:05:00 | Incline | 5 |
| 00:05:20 | Speed | 6 |
| 00:07:00 | Speed | 8 |

Thereafter, the fitness device 110 may operate according to the uploaded schedule, and during operation, the fitness device 110 may measure an exercising motion of the user using the fitness equipment and update information (the exercise information and/or health information) related to the exercising motion.

For example, the fitness device 110 may update information such as the consumed calories, the distance, the speed, the level, the incline, the exercise time, the heart rate, and the like.

When the pieces of information related to the exercising motion are updated, if an updated value exceeds the health information, the fitness device 110 may transmit a notification message for warning or alarming to the client device 120 (S22050) and lower an exercise level.

For example, when the updated heart rate exceeds the critical heart rate (critical value), the fitness device 110 may transmit a warning message to the client device 120 and lower the exercise level.

The fitness device 110 may transmit the updated exercise information and health information to the client device 120 through a notification message (S22060).

When the exercising motion of the user is terminated, the client device 120 may download changed, updated, or added exercise information and/or health information after the termination of the fitness from the fitness device 110 (S22070).

Here, the downloading may be performed through a method as follows.
When the information desired to be downloaded is an object type of information, the schedule information is downloaded using an object transfer service (OTS).
When the information desired to be downloaded is stored in the characteristic, the information is downloaded through a read long characteristic value.

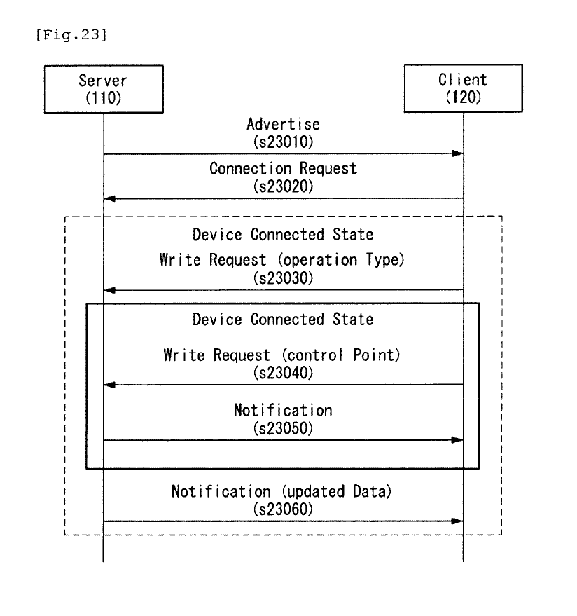

FIG. 23 illustrates an example of a method for setting an operation type of the fitness device to Interactive of (a) of FIG. 21 and a corresponding operation of the fitness device.

First, step S23010 and step S23020 are the same as step S7010 and step S7040 of FIG. 7, so a description thereof will be omitted.

In order to set the operation type of the fitness device to interactive, the client device 120 transmits a write request message to the fitness device (S23030).

Thereafter, in a case in which the client device 120 wants to control an operation of the fitness device, the client device 120 transmits a write request message requesting write of a control point of the characteristic of the fitness device illustrated in (b) of FIG. 21 (S23040).

For example, in a case in which the client device 120 wants to change a speed of the fitness device to 5, the client device 120 may transmit the write request message to change the speed to 5.

Whenever an operation of the fitness device 110 is intended to be changed, the client device 120 may transmit the write request message to change the operation of the fitness device.

When the user starts to exercise (fitness) through the fitness device 110, the fitness device 110 may measure an exercising motion of the user and update information (the exercise information and/or health information) related to the exercising motion.

For example, the fitness device 110 may update the consumed calories, the distance, the speed, the level, the incline, the exercise time, the heart rate, and the like.

When the pieces of information related to the exercising motion are updated, if an updated value exceeds the health information, the fitness device 110 may transmit a notification message for warning or alarming to the client device 120 (S23050) and lower an exercise level.

For example, when the updated heart rate exceeds the critical heart rate (critical value), the fitness device 110 may transmit a warning message to the client device 120 and lower the exercise level.

The fitness device 110 may transmit the updated exercise information, health information or added exercise information and/or health information to the client device 120 through a notification message (S23060).

Or, the fitness device 110 may transmit the notification message to inform that the operation of the fitness device has been terminated.

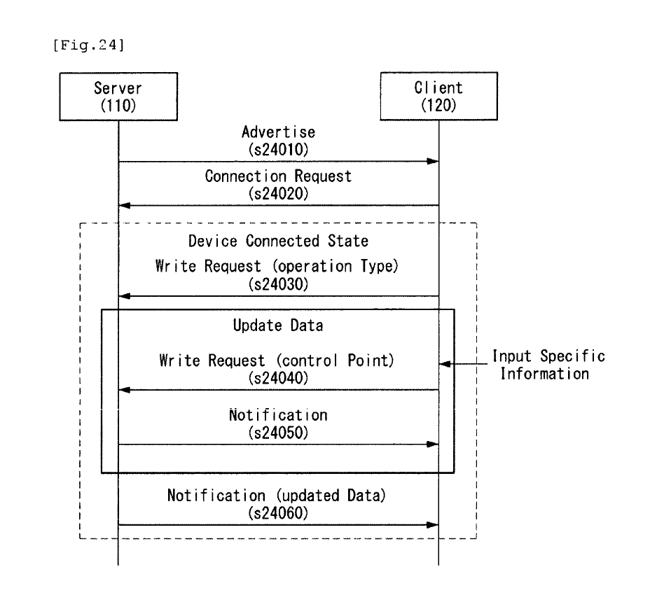

FIG. 24 illustrates an example of a method for setting an operation type of the fitness device to Manual of (a) of FIG. 21 and a corresponding operation of the fitness device.

First, step S24010 and step S24020 are the same as step S7010 and step S7040 of FIG. 7, so a description thereof will be omitted.

In order to set the operation type of the fitness device to Manual, the client device 120 transmits a write request message to the fitness device (S24030).

Thereafter, in a case in which information for controlling the fitness device is input from the outside, the client device 120 transmits a write request message requesting write of a control point of the characteristic of the fitness device illustrated in (b) of FIG. 21 (S24040).

For example, in a case in which control information for changing an operation of the fitness device is input to the client device from the user or an external device, the client device may change an operation of the fitness device through the write request message.

When the user starts to exercise (fitness) through the fitness device 110, the fitness device 110 may measure an exercising motion of the user and update information (the exercise information and/or health information) related to the exercising motion.

For example, the fitness device 110 may update the consumed calories, the distance, the speed, the level, the incline, the exercise time, the heart rate, and the like.

When the pieces of information related to the exercising motion are updated, if an updated value exceeds the health information, the fitness device 110 may transmit a notification message for warning or alarming to the client device 120 (S24050) and lower an exercise level.

For example, when the updated heart rate exceeds the critical heart rate (critical value), the fitness device 110 may transmit a warning message to the client device 120 and lower the exercise level.

The fitness device 110 may transmit the updated exercise information, health information or added exercise information and/or health information to the client device 120 through a notification message (S24060).

Or, the fitness device 110 may transmit the notification message to inform that the operation of the fitness device has been terminated.

The operation method of the fitness device may be set through the methods described above with reference to FIGS. 21 to 24, and information of an exercising motion of the user may be measured and obtained by controlling an operation of the fitness device.

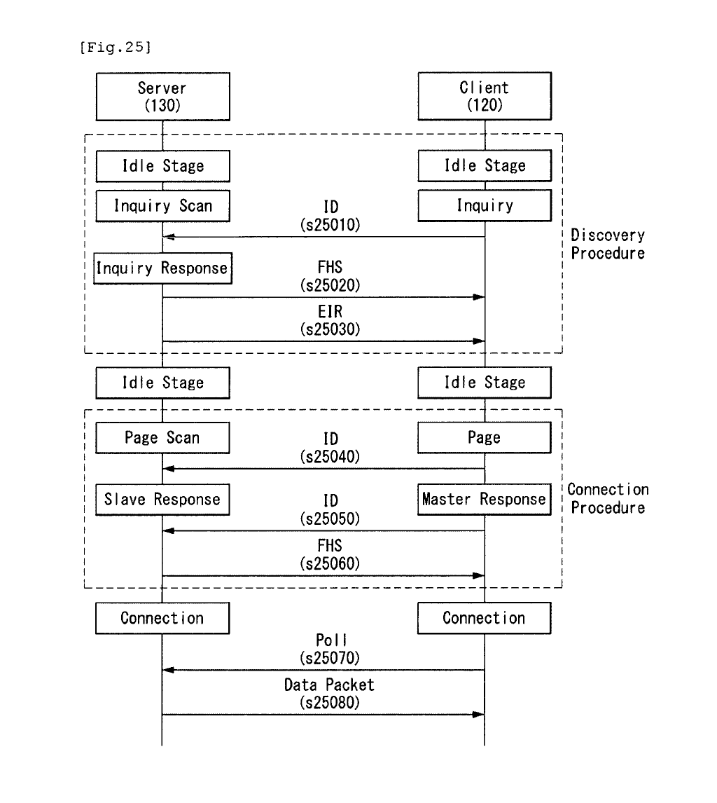

FIGS. 25 through 27 are views illustrating examples of a method for transmitting and receiving data using Bluetooth BR/EDR and a data format to which the present invention is applicable.

Referring to FIGS. 25 through 27, the fitness device service described above with reference to FIGS. 7 through 24 may also be provided through Bluetooth BR/EDR, as well as through the Bluetooth LE.

As illustrated in FIG. 25, in the Bluetooth BR/EDR, a device and a service that may be provided may be discovered through a discovery procedure and may be connected to and synchronized with another device through a connection procedure.

Discovery Procedure

The fitness device 110 and the client device 120 are in an idle state, and in order to perform Bluetooth BR/EDR discovery, the client device 120 may enter an inquiry state and the fitness device 110 may enter an inquiry scan state.

In the inquiry state, the client device 120 transmits an ID packet to the fitness device 110 to perform the Bluetooth BR/EDR discovery procedure (S25010).

In response to the ID packet, the fitness device 110 receives a frequency hop synchronization (FHS) packet to the client device within 625 us (S25020).

In a case in which the fitness device 110 wants to transmit additional information (for example, a provided service and information that may be provided with respect to the service) regarding the fitness device 110, the fitness device may set an enhanced inquiry packet (EIR) of the FHS packet to 1 and transmit the same.

When the EIR bit is set to 1, the fitness device 110 may transmit an EIR packet including the additional information to the client device 120 within 1250 us (S25030).

When the first device 200, which has checked the presence of another device, a service type, and additional information through the discovery procedure, wants to be connected with the second device 300, the first device 200 performs a paging procedure.

For example, the client device may check whether the fitness device may be able to provide the fitness device service described above through the discovery procedure and a device type and information that may be provided described above with reference to FIGS. 9, 10, and 17.

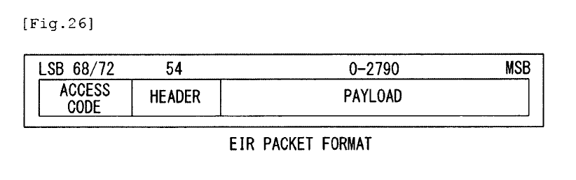

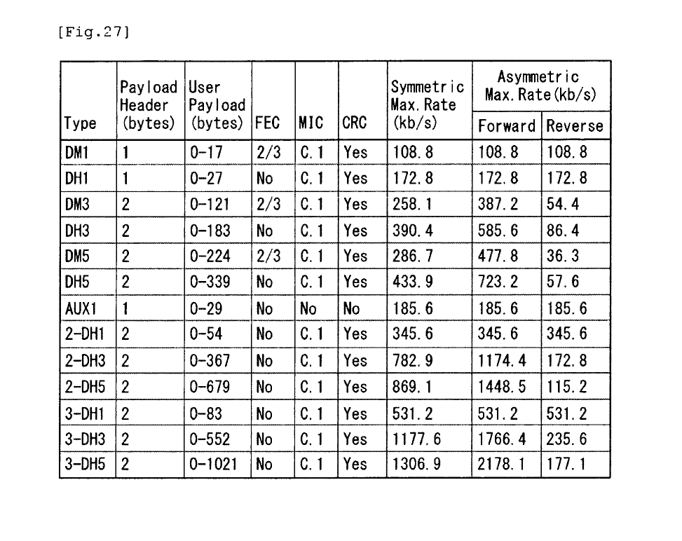

Here, the EIR packet may be configured to have such a packet format as that of FIG. 26, and a length of the payload may be a DM1, DM3, DM5, DH3, or DH5 type illustrated in FIG. 27.

Connection Procedure

In the paging procedure, the client device 120 enters a page state, and the fitness device 110 enters a page scan state.

In the connection procedure, the fitness device 110 and the client device 120 may tune a channel and timing for exchanging data using an ID packet and an FHS packet.

In detail, the client device in the page state 120 transmits an ID packet to the fitness device 300 (S25040).

When the fitness device 110 receives the ID packet transmitted from the client device, the client device 120 enters a BR/EDR master response state of the BR/EDR page state, and the fitness device 110 enters a BR/EDR slave state of the BR/EDR page state.

Thereafter, the client device 120 transmits a second ID packet in the channel in which the ID packet has been transmitted, to the fitness device (S25050).

Upon receiving the second ID packet, the fitness device 110 transmits an FHS packet to the client device 120 for the purpose of synchronization (S25060).

When the paging procedure is completed, the client device 120 and the fitness device 110 are switched to a BR/EDR connection state.

Thereafter, the fitness device 110 is switched to a hopping pattern of the client device 120, and in order to check this, the client device 120 transmits a poll packet to the fitness device 110 (S25070). Upon receiving the poll packet, the fitness device 110 transmits a data packet to the client device 120 as a response to the poll packet (S25080), and the Bluetooth BR/EDR connection procedure is terminated.

Through this procedure, the fitness device service allowing for measuring an exercising motion of the user and outputting a measurement result through the Bluetooth BR/EDR, as well as through Bluetooth LE may be provided.

While the present invention has been shown and described in connection with the embodiments, it will be apparent to those skilled in the art that modifications and variations can be made without departing from the spirit and scope of the invention as defined by the appended claims.

What is claimed is:

1. A method for transmitting and receiving data by a client device with a fitness device using Bluetooth, the method comprising:
receiving an advertising message including at least one of type information of the fitness device or service information indicating whether a fitness service is provided, from the fitness device;
performing a connection procedure with the fitness device;
transmitting a request message requesting feature information of the fitness device from the fitness device;
receiving a response message including the feature information from the fitness device;
transmitting a first write request message including first control information for controlling the fitness device based on the feature information; and
receiving a first write response message in response to the first write request message,
wherein the feature information is information related to the fitness service.

2. The method of claim 1, wherein the feature information includes at least one of device information indicating the fitness device or exercise information indicating an exercising motion.

3. The method of claim 1, further comprising:
transmitting a second write request message requesting write of user data to the fitness device; and
receiving a second write response message in response to the second write request message.

4. The method of claim 3, further comprising:
when the user data is updated by the fitness device, receiving the updated user data from the fitness device.

5. The method of claim 1, further comprising:
transmitting a scan request message for requesting additional information to the fitness device; and
receiving a scan response message including the additional information in response to the scan request message.

6. The method of claim 4, further comprising:
when a specific value of the updated user data exceeds a predetermined threshold value, receiving a notification message including alarm information indicating that the specific value exceeds the predetermined threshold value.

7. The method of claim 1, further comprising:
transmitting a third write request message including operation type information indicating an operation method of the fitness device; and
receiving a third write response message in response to the third write request message.

8. The method of claim 1, wherein the operation method is one of automatic control, manual control, and interactive control.

9. The method of claim 8, further comprising:
when the operation method indicates automatic control, transmitting scheduling information for setting the operation method to the fitness device,
wherein the scheduling information is comprised of one or more objects.

10. The method of claim 9, wherein the scheduling information includes at least one of time information indicating an operation time, operation information indicating a scheduling operation, or a set value of an operation.

11. The method of claim 8, further comprising:
when the operation method indicates manual control,
receiving a second control information for controlling a specific operation of the fitness device from a user or other device;
transmitting a second write request message including the second control information to the fitness device; and
receiving a second write response message in response to the second write request message.

12. The method of claim 8, further comprising:
when the operation method indicates interactive control,
transmitting a second write request message including second control information to the fitness device according to a set scheduling information; and
receiving a second write response message in response to the second write request message.

13. A device in a method for transmitting and receiving data by a client device with a fitness device using Bluetooth, the device comprising:
a communication unit configured to communicate with the fitness device wirelessly or in a wired manner; and
a processor functionally connected to the communication unit,
wherein the processor is configured to perform control to
receive an advertising message including at least one of type information of the fitness device and service information indicating whether a fitness service is provided, from the fitness device,
perform a connection procedure with the fitness device,
transmit a request message requesting feature information that can be provided by the fitness device to the fitness device,
receive a response message including the feature information from the fitness device,
transmit a write request message including control information for controlling the fitness device on the basis of the feature information, and
receive a write response message in response to the write request message,
wherein the feature information indicates information related to the fitness service.
